(19) United States
(12) Patent Application Publication
(10) Pub. No.: US 2021/0097114 A1
(43) Pub. Date: Apr. 1, 2021

(54) Concept Similarity Measure Based, Scope-Aware and Dependency-Aware Hierarchical Service Discovery

(71) Applicant: International Business Machines Corporation, Armonk, NY (US)

(72) Inventor: Jim Tao, Sewickley, PA (US)

(21) Appl. No.: 16/585,063

(22) Filed: Sep. 27, 2019

(51) Int. Cl. G06F 16/955; G06F 16/9535; G06F 16/958; G06F 16/9538; G06N 5/02

(52) U.S. Cl. CPC G06F 16/955; G06F 16/9535; G06N 5/02; G06F 16/9538; G06F 16/958

(57) ABSTRACT

Technology for helping web services end users connect with desired web services that are identified by the lowest level nodes in a hierarchical data structure, with a higher level nodes include information about the nodes under them in the hierarchy. Various embodiments consider one or more of the following types of information in selecting web services of potential interest: semantic information related to the subject matter of the desired web service, scope information relating to the desired web service, and/or hierarchy information relating to the desired web service.

### BACKGROUND

Web services are known. For the purposes of this document, web services are hereby defined as: computer code for performing function(s) upon requests received over communication network, where the service is either a services oriented architecture type service and/or a microservice.

With the rise of representational state transfer (REST), or RESTful, web services, accessing remote Application Programming Interfaces (APIs) and data is as easy as accessing web pages. At the same time, advances in cloud computing and other technologies have significantly lowered the cost of employing web services to conduct businesses. The popularity of microservice architecture pattern makes the proliferation of web services possible within and among business entities.

Universal Description, Discovery, and Integration (UDDI) is a registry for Simple Object Access Protocol (SOAP) based web services. It utilizes taxonomy to classify web services.

Web Services Distributed Management (WSDM) is a web service standard for managing and monitoring the status of SOAP based web services.

Ontology is used to describe knowledge as a set of concepts and their relationships in a knowledge domain. In ontology, reasoning can be used with formal logic rules to derive more knowledge from existing one. To facilitate the description of concepts, as well as their properties and their relationships, shared vocabulary and taxonomies are defined in a specific ontology domain.

Web Ontology Language (OWL), as well as its newer version OWL 2, is an ontology standard, which was originally developed in academic research to present data on the web in a machine-understandable format. Ontology Web Language for Services (OWL-S) is built on top of OWL. It provides a standard vocabulary to describe services semantically. Furthermore, it defines the preconditions and conditional effects of web services and enriches semantic representations of their input data and output data. It enables users and software agents to automatically discover, invoke, compose, and monitor web services under specified constraints.

Semantic Annotations for WSDL and XML Schema (SAWSDL) is a World Wide Web Consortium standard defining a set of extension attributes for the Web Services Description Language (WSDL) and XML Schema to allow SOAP based web services to use ontology concepts to describe the semantic meaning of the artifacts of these web services.

UDDI, WSDM, OWL-S and SAWSDL lack industry adoption as of this writing.

Some web sites or web service providers list the information of public RESTful web services, functioning as a web service marketplace or directory.

### SUMMARY

According to an aspect of the present invention, there is a method, computer program product and/or system that performs the following operations (not necessarily in the following order): (i) receiving a keyword search from a user; (ii) exploring a web service syntactical structure to facilitate semantic analysis; (iii) performing multidimensional semantic analysis based on the exploration of a web service syntactical structure, with the multidimensional semantic analysis including consideration of at least the following dimensions: classification hierarchy, semantic concept relationship, concept topological distance, web service parameter dependency, and web service parameter scope; and (iv) identifying a set of web service(s) based, at least in part, upon the multidimensional semantic analysis.

According to an aspect of the present invention, there is a method, computer program product and/or system that performs the following operations (not necessarily in the following order): (i) receiving a keyword search from a user; (ii) exploring a web service syntactical structure to facilitate semantic analysis; (iii) performing multidimensional semantic analysis based on the exploration of a web service syntactical structure, with the multidimensional semantic analysis including consideration of at least the following dimension: classification hierarchy; and (iv) identifying a set of web service(s) based, at least in part, upon the multidimensional semantic analysis.

According to an aspect of the present invention, there is a method, computer program product and/or system that performs the following operations (not necessarily in the following order): (i) receiving a keyword search from a user; (ii) exploring a web service syntactical structure to facilitate semantic analysis; (iii) performing multidimensional semantic analysis based on the exploration of a web service syntactical structure, with the multidimensional semantic analysis including consideration of at least the following dimension: web service parameter scope; and (iv) identifying a set of web service(s) based, at least in part, upon the multidimensional semantic analysis.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a table helpful in understanding the operation of the first embodiment system;

FIG. 5 is a block diagram view of a second embodiment of a system according to the present invention;

FIG. 6 is an ontology diagram helpful in understanding operation of the second embodiment system;

FIG. 7 is an ontology diagram helpful in understanding operation of the second embodiment system; and

FIG. 8 is a flowchart showing a first embodiment method performed, at least in part, by the first embodiment system.

### DETAILED DESCRIPTION

Some embodiments of the present invention are directed to technology for helping web services end users connect with desired web services that are identified by the lowest level nodes in a hierarchical data structure, with a higher level nodes include information about the nodes under them in the hierarchy. Various embodiments consider one or more of the following types of information in selecting web services of potential interest: semantic information related to the subject matter of the desired web service, scope information relating to the desired web service, and/or hierarchy information relating to the desired web service. This Detailed Description section is divided into the following subsections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be any thing made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

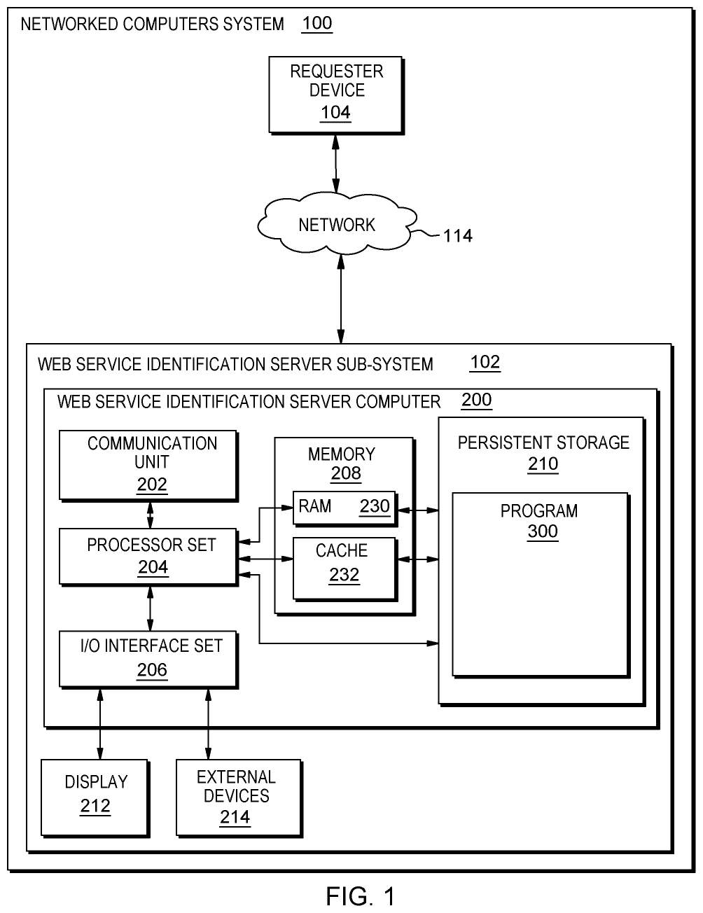

As shown in FIG. 1, networked computers system 100 is an embodiment of a hardware and software environment for use with various embodiments of the present invention. Networked computers system 100 includes: web service identification server subsystem 102 (sometimes herein referred to, more simply, as subsystem 102); requester device 104; and communication network 114. Server subsystem 102 includes: web service identification server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. EXAMPLE EMBODIMENT

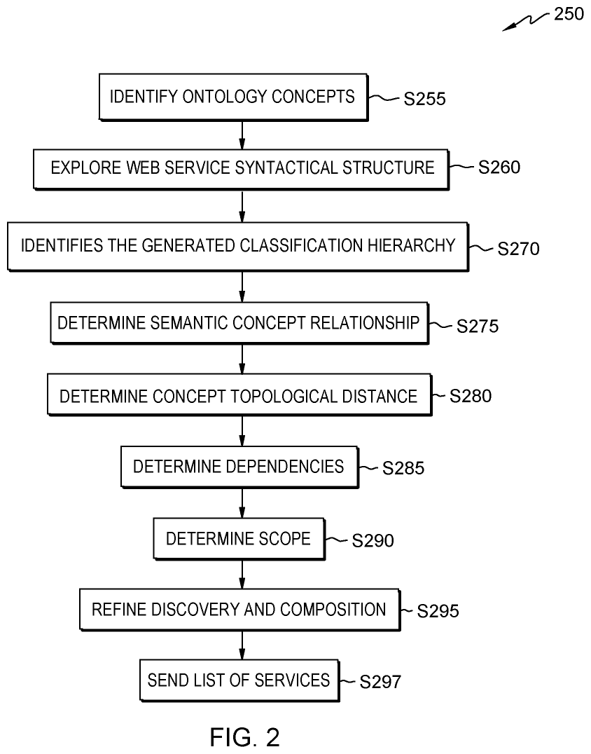

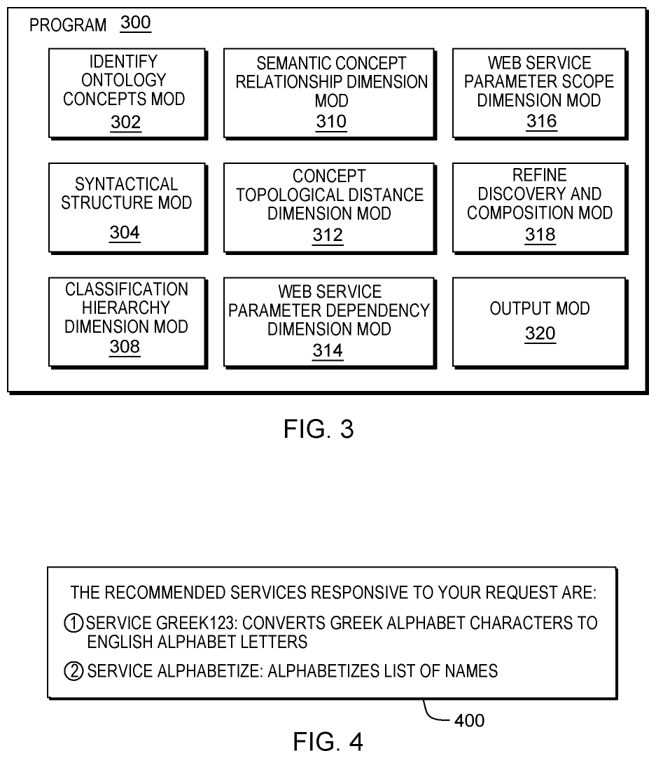

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3. The method of flowchart 250 represents a multipronged approach.

Processing begins at operation S255, where identify ontology concepts module (“mod”) 302 identifies ontology concepts started with a keyword search. In this example, a user of requester device 104 desires to compose a single service that: (i) translates names made of Greek alphabet characters into English alphabet characters; and (ii) alphabetizes the translated list of names. As part of operation S255, a keyword search string, composed by the user, is communicated from requester device 104 to identify ontology concepts module 302 over communication network 114 (see FIG. 1).

Processing proceeds to operation S260, where syntactical structure mod 304 explores web service syntactical structure to facilitate semantic analysis(new and existing).

The five (5) operations S270, S275, S280, S285 and S290, respectively described in the following five (5) paragraphs novel multidimensional semantic analysis. Each operation relates to one of the dimensions considered in the multidimensional analysis. Alternatively, more dimensions, or fewer dimensions can be considered in various embodiments of the present invention.

Processing proceeds to operation S270, where classification hierarchy dimension mod 308 identifies the dynamically generated classification hierarchy. The classification hierarchy is usually generated dynamically in an independent process, not part of the individual service search and composition process.

Processing proceeds to operation S275, where semantic concept relationship dimension mod 310 determines a semantic concept relationship.

Processing proceeds to operation S280, where concept topological distance dimension mod 312 determines concept topological distance.

Processing proceeds to operation S285, where web service parameter dependency dimension mod 314 determines dependencies.

Processing proceeds to operation S290, where web service parameter scope dimension mod 316 determines scope.

Processing proceeds to operation S295, where refine discovery and composition mod 318 refines discovery and composition through a user guided iterative process.

Processing proceeds to operation S297, where output mod 320 outputs a recommended list of services (as determined by the previous operations) to requester device 104 over communication network 114. An end user (for example, services designer) uses the recommended list of services to compose a new service. As shown in FIG. 4, screenshot 400 is displayed to the end user on requester device 104.

### III. FURTHER COMMENTS AND/OR EMBODIMENTS

Some embodiments of the present invention recognize the following facts, potential problems and/or potential areas for improvement with respect to the current state of the art: (i) no standard is available to describe how to manage RESTful web services, such as how to describe, publish, discover and consume existing RESTful web services; (ii) keyword based search is one of the most efficient ways to search web pages for human consumption; (iii) a typical keyword based search may not be enough for web service search due to the fact that web services are essentially web APIs (Application Programming Interface); (iv) for example, unlike a document, an API is a set of clearly defined methods describing how computing programs communicate with each other; (v) each defined method has a standard structure with two distinguishing sets of data: input and output; and/or (vi) traditional keyword based search does not explore or utilize the important API structure and characteristics.

Some embodiments of the present invention recognize the following facts, potential problems and/or potential areas for improvement with respect to the current state of the art: (i) web service discovery and composition is an active research topic; (ii) researchers have proposed a number of ways to match web services or compose web services using keyword-search, syntactic, or semantic approaches, or a certain combination of; (iii) these approaches may not be scalable and perform well in a cloud computing environment where thousands or millions of web services are available; (iv) automated planning and scheduling is a branch of Artificial Intelligence (AI) concerning the theories and implementations of the executions of a number of related actions or tasks to achieve a certain goal by a computing system (such as a robot or an unmanned vehicle); (v) Stanford Research Institute Problem Solver (STRIPS) and Planning Domain Definition Language (PDDL) are commonly used action languages to describe problems and solutions in this domain; (v) most problems in this domain are combinatorial problems; (vi) the main difficulty to find a practical solution is to overcome combinatorial explosion; (vii) researchers in this field proposed various methods to compose web services in scenarios where the solution is effective when the number of services is limited; (viii) the web service discovery and composition is an active research field in the past one and half decades; (ix) the focus of the researches is how to identify relevant web services and how to create new web services based on existing ones by utilizing the semantic meaning of the web services and their input/output (I/O) parameters; (x) scalability and applicability of the existing research results for real world applications has not been sufficiently addressed; and/or (xi) there is a need in the art for new methods and techniques to efficiently search and consume existing RESTful web services or to use them to compose new web services (instead of manually looking for and identifying available services from different vendors in a web service marketplace or directory).

Some embodiments of the present invention may include one, or more, of the following operations, features, characteristics and/or advantages: (i) relate to service discovery and composition from large collections of individual web services; (ii) more specifically, relate to systems and methods for web service developers to efficiently identify relevant existing services and compose new services based on existing ones in distributed computing systems, such as internet; (iii) searching relevant web services and composing new web services using existing ones; (iv) a hierarchical dynamic grouping mechanism based on syntactical and semantic information of web services is introduced to categorize web services for discovery efficiency; and/or (v) additionally, a semantic-based dependency-aware and scope-aware web service searching and composing method is proposed to create a scalable and efficient web service discovery and composition system.

Web services is a request-response two-way communication with data exchange between two parties. Based on the nature of these services, they can be categorized into two groups: query services and non-query services. The goal of query services is to retrieve data without modifying the data in the backend data source. The goal of non-query services may involve the activities of creating, updating, or deleting data in the data source. Although non-query services are semantically different from query services, they are syntactically similar to the query ones from their syntax format point of view and can be discussed and processed in a similar way. While the examples set forth herein may focus on query type services, it should be understood that various embodiments of the present invention may be equally applicable to non-query type services. The preconditions and effects of web services are not discussed here either for the same reason. Also assumed is that each web service has only one query operation defined for the same reason, but it should be understood that various embodiments of the present invention may be applicable to web services that have more than one defined query operation. The data source of web services where the data is stored can be distributed, federated, or provided by third parties. Also assumed is that each web service has its own data source. The relationships and dependencies of web service data sources is not considered as a factor for web service composition in some embodiments of this invention for the purpose of simplicity.

Each web service, of the many, many available web services, has its respective input parameters and output parameters. Because the output parameters describe what types of data users want to retrieve, identifying the web services that are able to provide the desired output data is the starting point in the service discovery and composition process. If no single web service is found to satisfy user's request, a directed acyclic graph (DAG) based backward chaining approach can be used to create desired web services through composition. The meaning of web service I/O parameters are used to identify and compose web services in plurality of state of art researches. This is one of the advantages of semantic web services discovery and composition. However, practically, the value of each parameter in a web service I/O definition also has a scope. It may or may not be defined in the data type definition of the parameters. For web service discovery and composition, a formal semantic based scope definition for each parameter in a web service is desirable. For example, assume the goal is to find or compose an auto insurance quote web service. Its input parameters are user information, user's driver license information, vehicle information, current insurance information and desired insurance policy information. The output parameter is a list of insurance quotes, including the selected insurance company's names, the insurance premiums and the matched policy details.

The generic semantic information of the I/O parameters may not be sufficient to identify whether an existing web service is a potential match for such a web service. There is no well-defined information on which geographic regions are covered by insurance companies that can be selected from an existing web service. If the desired web service allows the user specified in the input parameter lives on the United States east coast and an existing web service only offers insurance quotes for people living on the United States west coast or another country, then there is not enough information to detect that these two services are not a match. To automatically identify the scope of web service parameters, it is simpler to define them with their parameters if there are multiple parameters that need scope definition. If there is only one parameter scope needed to be defined, it is also reasonable to define it at the web service level or encoded in the web service precondition. For instance, the geographic region covered by the insurance policies offered through the above example can be defined with input user data, or defined at the entire service level as part of service definition if it is the only scope specified in this web service.

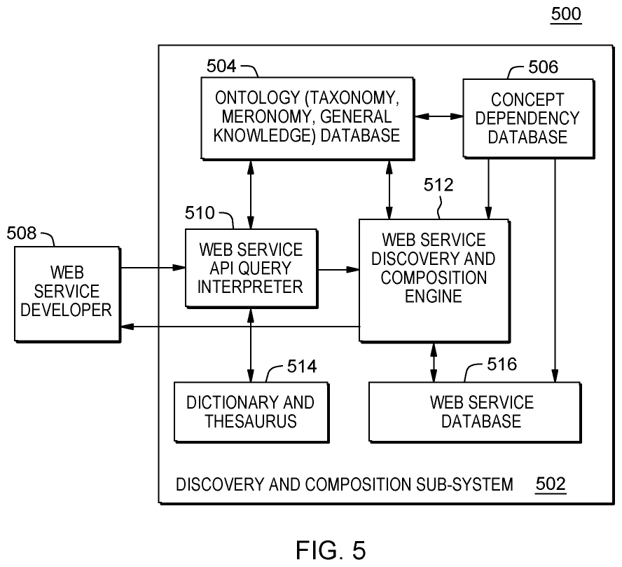

FIG. 5 illustrates an example diagram of web service discovery and composition system 502, including: discovery and composition sub-system 502; ontology (taxonomy, meronomy, general knowledge) database 504; concept dependency database 506; web service developer 508; web service API query interpreter 510, web service discovery and composition engine 512; dictionary and thesaurus 514; and web service database 516. FIG. 5 illustrates the overall structure and major components of discovery and composition subsystem 502. A web service developer 508 interacts with discovery and composition system 502 through a communication network.

Ontology (taxonomy, meronomy, general knowledge) database 504 is the store where ontology concepts and their relationships are saved. It also contains common taxonomies and classification systems, such as North American Industry Classification System (NAICS) and Linnaean taxonomy, to categorize web services.

Concept dependency database 506 stores the dependency relationships of the concepts that match the I/O parameters and descriptions of web services. A concept is defined as the dependent of concept set S_{c} if there exists a web service which has an output parameter matches the concept and the corresponding concepts of the web service's input parameters is set S_{c} or subset of S_{c}. Chained concept dependency may be implemented as well in certain embodiments.

When web service developer 508 sends a request of seeking or composing a desired web service implementation to discovery and composition system 502, web service API query interpreter 510 examines and processes the request first. If query interpreter 510 identifies any spelling errors using the dictionary provided by dictionary and thesaurus 514, it either informs developer 508 to correct them, or corrects them automatically. Then, query interpreter 510 consults ontology database 504 to match the I/O parameters and the description of the desired web service to the concepts defined in ontology database 504. If not all the parameters can be matched to a concept in ontology database 504, the thesaurus of dictionary and thesaurus 514 is used to locate synonymies or similar terms. In the event not all I/O parameters are matched, a request is sent back to developer 508 to change or clarify the parameters until all parameters are matched to concepts defined in ontology database 504.

Query interpreter 510 also checks whether the standard classification information of the desired web service is provided in the request. If not, query interpreter 510 provides developer 508 a list of recommended categories defined by standard taxonomies stored in ontology database 504. Developer 508 decides to which categories the desired web service belongs.

Web service discovery and composition engine 512 is the component implementing the core web service discovery and composition features. It receives the preprocessed query for a desired web service from keyword query interpreter 510, retrieves necessary ontology concept information from ontology database 504, identifies to which dynamic cluster the desired web service belongs, and compares the I/O parameters of the desired web service with the ones of existing web services stored in web service database 516 to find existing matching web services or to compose a new and optimized matching web service.

Dictionary and thesaurus 514 is a combination of a dictionary and a thesaurus. It is utilized by query interpreter 510 to correct spelling errors and to make sure that proper words are used in the names of parameters of web services to match the concepts defined in ontology database 504.

Web service database 516 is a database where existing web service information is stored. The information of these web service is updated regularly or dynamically by web service providers.

Both web service discovery and composition methods proposed in this invention relies on the web service I/O and non-I/O ontology based concept matching. To achieve this, a web service WS can be described in a 3-tuples form:

WS=<In,Out,Non-I/O>

In which In is the input of the web service. It has a number of parameters. Each of the parameters may correspond to a concept in a domain ontology in ontology database 504.

Out is the output of the web service and may contain one or multiple parameters. By the same token, each of the output parameters may match to a concept in the domain ontology in ontology database 504.

Non-I/O represents the non-I/O portion of the web service definition, such as name, URL path, type and other optional parts of the web service. The name and URL path of the web service may contain a number of meaningful words, each of which may map to a concept in a domain ontology. The type specifies the basic type of the web service, such as query or update. As aforementioned, the web service type discussed in this invention is query only for simplicity. The optional parts may include the web service's description, precondition, effects and so on. The web service provider decides whether and which ontology concepts should be associated with these Non-I/O concepts.

It is at the discretion of the web service provider to choose which domain ontology to use if there are multiple domain ontologies in ontology database 504.

Assume WS_{d} is the desired web service developer 508 and it needs to find or create utilizing discovery and composition system 502. In_{d} is the input of WS_{d}, and Out_{d} is the output of WS_{d}. Also assume WSₑ is an existing web service in web service database 516. Inₑ is the input of WSₑ, and Outₑ is the output of WSₑ. Definitions regarding web service partial match and perfect match are below:

Definition 1: Perfect Input Match: If there is a semantically matching parameter with the same scope in Inₑ for each parameter in In_{d} and vice versa, WSₑ is a perfect input match for WS_{d}.

Definition 2: Perfect Output Match: If there is a semantically matching parameter with the same scope in Outₑ for each parameter in Out_{d}, WSₑ is a perfect output match for WS_{d}.

Definition 3: Perfect Non-I/O Definition Match: If the concepts in the non-I/O parts of description of WS_{d}, which does not include the web service I/O parameters, match the ones in the description of WSₑ, WSₑ is a perfect Non-I/O definition match for WS_{d}.

Definition 4: Perfect Match: If WSₑ is a perfect input match, a perfect output match and a perfect Non-I/O definition match for WS_{d}, WSₑ is a perfect match for WS_{d}.

Definition 5: Partial Input Match: If only part of parameters in In_{d} have semantically matching parameters with the same scope in Inₑ, WSₑ is a partial input match for WS_{d}.

In Definition 6: Partial Output Match: If only part of parameters in Outₑ have semantically matching parameters with the same scope in Out_{d}, WSₑ is a partial output match for WS_{d}.

Definition 7: Partial Non-I/O Definition Match: If only part of the concepts in the semantic description of WS_{d}, which does not involve the web service I/O parameter and their description, match the ones in the description of WSₑ, WSₑ is a partial Non-I/O definition match for WS_{d}.

Definition 8: Partial Match: If WSₑ is a partial or perfect input match for WS_{d}, and a partial or perfect output match for WS_{d}, and a partial or perfect Non-I/O definition match for WS_{d}, but not a perfect match for WS_{d}, then WSₑ is a partial match for WS_{d}.

In certain embodiments, to improve the efficiency of web service discovery and composition, published existing web services in web service database 516 are grouped into hierarchies of categories. As part of ontology database, the hierarchies of standard categories are based on the classifications created by industry, national or international standard bodies.

Categories and subcategories created using standard classifications is usually coarse grained. The smallest subcategory may contain thousands or more web services. In certain embodiments, to further categorize these web services into finer groups, a hierarchical clustering algorithm, such as Unweighted Pair Group Method with Arithmetic Mean (UPGMA), can be used to generate these fine-grained groups, called dynamic clusters. These dynamic clusters, under the leave nodes of a standard classification hierarchy, are created dynamically by disco and very and composition system 502.

To use algorithms like UPGMA, a distance function between any two web services need to be defined. To define such a distance function or a similarity measure which is the opposite of distance function, the structure of web services is utilized to form groups of concepts that are used to define semantic meaning of web services. In certain embodiments, to facilitate the calculation of the distance between two web services, a similarity measure CS_{c1,c2} between two concepts C₁ and C₂ in an ontology can be defined as following Equation (1):

$${CS}_{c 1 , c 2} = \{ \begin{matrix}1 & {C}_{1} = {C}_{2} \\ \sqrt{{k}_{n} {e}^{- αl} \frac{1 - {e}^{- r}}{1 + {e}^{- r}}} & {C}_{1} \neq {C}_{2}\end{matrix} \qquad ( 1 )$$

in which α is a weighting coefficient for l and l is the shortest length between concepts C₁ and C₂ in the hierarchical graph of a taxonomy. If there are multiple taxonomies in the ontology, the one selected by web service developer 508 is used. If no taxonomy is selected, the one that is actually utilized may be decided later during the web service selection process.

Ratio r is used to measure the level of abstraction of concepts C₁ and C₂ in the taxonomy hierarchy, which is usually a tree structure. It is based on the idea that, if the distance between two concepts is given, more specialized concepts are more similar comparing to more generic concepts. For example, dog and wolf are animals. They are more similar because they are more specific concepts. Vertebrate and invertebrate are also animals. But they are less similar because they are more general concepts. r can be calculated using Equation (2):

$$r = β \frac{{h}_{1}}{{h}_{2}^{1 / 2}} \qquad ( 2 )$$

in which β is the coefficient of ratio r. h₁ is the depth of their closest common ancestor of concepts C₁ and C₂ in the taxonomy hierarchy. This ancestor represents the most specific concept which is an ancestor of both C₁ and C₂. h₂ is the arithmetic average of the lengths between them and their leaf descendants (descendants with no children), that is, the arithmetic average of the depths of their leaf descendants in the two subtrees where C₁ and C₂ are the root node. These root descendants represent the most specific concepts which have C₁ and/or C₂ as their ancestor in the taxonomy hierarchy.

The kₙ in Equation (1) is a relationship similarity coefficient of concepts C₁ and C₂ based on the percentage of the shared neighborhood concepts of these two concepts to reduce structural misclassification as shown by Equation (3):

$${k}_{n} = \frac{{\sum }_{i ⋐ R} \frac{\vert {S}_{i , C 1} ⋂ {S}_{i , C 2} \vert}{\vert {S}_{i , C 1} ⋃ {S}_{i , C 2} \vert}}{\vert R \vert} \qquad ( 3 )$$

In which Si,c₁ is the set of concepts directly linked to concept C₁ in the type of relationship i in the ontology. There are usually multiple types of relationships defined in an ontology for concepts C₁ and C₂, such as “is-a” relationship, “has-a” relationship or “part-of” relationship. R is the set of these relationships. By the same token, Si,c₂ is the set of concepts directly linked to concept C₂ in the relationship type i in the ontology.

The similarity between two web services may be further calculated based on the similarity of their three concept sets: input set, output set and non-IO set. These concept sets of a web service are generated from their input parameters, output parameters and Non-IO part of the aforementioned 3-tuple representation of a web service. The formula used to calculate the similarity between web service WS₁ and WS₂ is following Equation (4):

WSS_{ws1,ws2}=αᵢWSSᵢ+αₒWSSₒ+αₙWSSₙ (4)

in which αᵢ, αᵢ and αᵢ are weighting coefficients of web service input similarity WSSᵢ, output similarity WSSₒ and non-I/O similarity WSSₙ. WSSᵢ may be defined as below is Equation (5):

$${WSS}_{i} = \frac{1}{Max ( {I}_{1} , {I}_{2} )} {\sum }_{j = 1}^{Min ( {I}_{1} , {I}_{2} )} {CS}_{j} \qquad ( 5 )$$

in which I₁ and I₂ are the number of input parameters of web service WS₁ and WS₂. CSⱼ is the concept similarity between the two optimally selected input concepts from each of two web services' input set. WSSₒ and WSSₙ can be defined similarly as web service output similarity and web service non-I/O similarity. If the scopes of matching web service parameters do not match the ones of the desired web service parameters, it is necessary to detect whether there exists such a set of matching web services that their combined scope of parameters will cover the scopes of the desired web service parameters. To find the optimal set of such matched web services is the set cover problem. This is a classic NP-complete problem. Approximation algorithms, such as greedy based algorithms, can be utilized to find the solutions close to the optimal one in polynomial time.

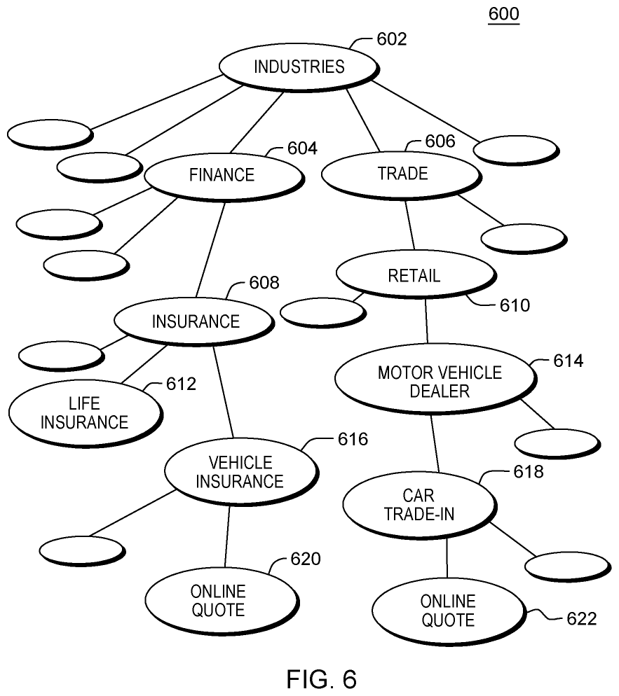

FIG. 6 is graph 600, representing part of an industry classification and dynamically generated clusters. Graph 600 includes: industries node 602; finance node 604; trade node 606; insurance node 608; retail node 610; life insurance node 612; motor vehicle dealer node 614; vehicle insurance node 616; car trade-in node 618; online quote node 620; and online quote node 622. Car trade-in node 618 is a dynamic cluster.

Graph 600 illustrates two different types of online quote services in the hierarchical structure of an industry based taxonomy. In this graph, two of the child nodes of root node industries 602 are node finance 604 and node trade 606 representing finance industry category and trade industry category. Node vehicle insurance 616 is a descendent of node finance 604 and it is one of the finest categories in the taxonomy. Node motor vehicle dealer 250 is a descendent of node trade 606 and it is also a finest category of the taxonomy. Node online quote 620 is a dynamic cluster generated by discovery and composition system 502. It is a child node of node vehicle insurance 616, which means it represents a finer category of online auto insurance quote service extending the standard industry classification. Both node car trade-in 618 and node online quote 622 are dynamic clusters generated by discovery and composition system 502 as well. It means their definitions are beyond the standard industry classification. Node car trade-in 618 is a child node of node motor vehicle dealer 250. Node online quote 622 is a child node of node car trade-in 618. It means node online quote 622 represents the group of online vehicle trade-in quote services.

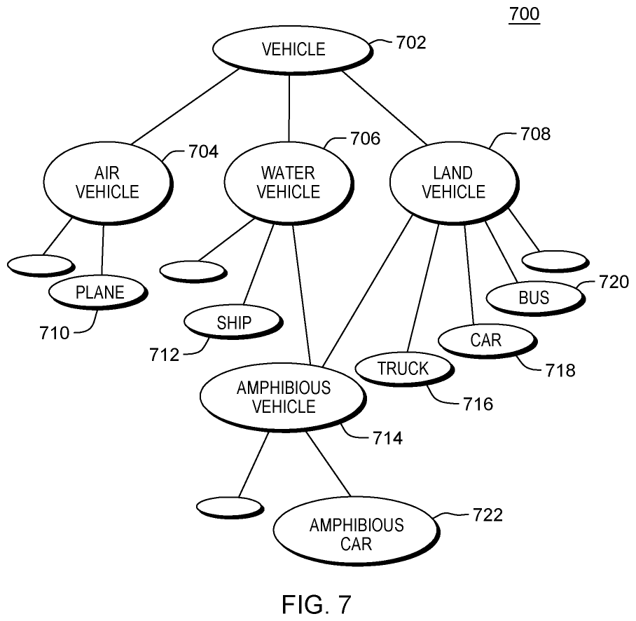

FIG. 7 shows graph 700, whose nodes represent certain types of vehicles in a simple vehicle taxonomy. Graph 700 includes: vehicle node 702; air vehicle node 704; water vehicle node 706; land vehicle node 708; plane node 710; ship node 712; amphibious vehicle node 714; truck node 716; car node 718; bus node 720; and amphibious car node 722. FIG. 7 is a graph illustrating the relationships among some types of vehicles in a simple vehicle taxonomy. Node vehicle 702 is the root node. Node water vehicle 706 is one of its children. As another child node of node vehicle 702, node land vehicle 708 is a subcategory of the vehicle category represented by the root node. Node ship 712 is a child of node water vehicle 706. Node truck 716 and node car 718 are child nodes of node land vehicle 708. Node amphibious vehicle 714 has two parent nodes. One is node water vehicle 706 and the other is node land vehicle 708. Node amphibious car 722 is a child node of node amphibious vehicle 714.

Assume each node in the graph represents a concept in the ontology database 504. The concept similarity measures between these concepts may be computed accordingly. For instance, the similarity measures between concept car and four other concepts: truck, amphibious car, vehicle and ship can be calculated as below. In certain embodiments, the default value for coefficients α and β are 0.2 and 1.2. Similarity measure between car and truck will now be set forth:

$$distance l = 2 , assuming similarity coeffictient {k}_{n} = 0.6 , \\ ratio r = β \frac{{h}_{1}}{{h}_{2}^{1 / 2}} = 1.2 \times \frac{2}{{2}^{1 / 2}} = 1.70$$

$$similarity measure CS = \sqrt{{k}_{n} {e}^{- αl} \frac{1 - {e}^{- r}}{1 + {e}^{- r}}} = \sqrt{0.6 \times {e}^{- 0.2 \times 2} \frac{1 - {e}^{- 1.70}}{1 + {e}^{- 1.70}}} = 0.53$$

Similarity measure between car and amphibious car will now be calculated: distance l=3, assuming similarity coefficient kₙ=0.5,

$$ratio r = β \frac{{h}_{1}}{{h}_{2}^{1 / 2}} = 1.2 \times \frac{2}{{2.5}^{1 / 2}} = 1.52$$

$$similarity measure CS = \sqrt{{k}_{n} {e}^{- αl} \frac{1 - {e}^{- r}}{1 + {e}^{- r}}} = \sqrt{0.5 \times {e}^{- 0.2 \times 2} \frac{1 - {e}^{- 1.52}}{1 + {e}^{- 1.52}}} = 0.42$$

Similarity measure between car and vehicle will be calculated: distance l=2, assuming similarity coefficient kₙ=0.5,

$$ratio r = β \frac{{h}_{1}}{{h}_{2}^{1 / 2}} = 1.2 \times \frac{2}{{2}^{1 / 2}} = 0.85$$

$$similarity measure CS = \sqrt{{k}_{n} {e}^{- αl} \frac{1 - {e}^{- r}}{1 + {e}^{- r}}} = \sqrt{0.5 \times {e}^{- 0.2 \times 2} \frac{1 - {e}^{- 0.85}}{1 + {e}^{- 0.85}}} = 0.37$$

Similarity measure between car and ship will now be calculated: distance l=4, assuming similarity coefficient kₙ=0.1,

$$ratio r = β \frac{{h}_{1}}{{h}_{2}^{1 / 2}} = 1.2 \times \frac{2}{{3}^{1 / 2}} = 0.69$$

$$similarity measure CS = \sqrt{{k}_{n} {e}^{- αl} \frac{1 - {e}^{- r}}{1 + {e}^{- r}}} = \sqrt{0.1 \times {e}^{- 0.2 \times 4} \frac{1 - {e}^{- 0.69}}{1 + {e}^{- 0.69}}} = 0.12$$

The above calculation of the values of the concept similarity measures demonstrates the importance of the distance between the concepts, the location of their closest common ancestor, and the location of their leaf descendants. Although for car, the similarity coefficients of truck, amphibious car and vehicle are the same or similar, the differences of their similarity measures are more significant. For truck, it has the largest value since its distance from car is smaller and their closest common ancestor is close to them. For amphibious car, although its distance from car is the largest, their closest common ancestor is not at the top and they are leaf nodes themselves. It makes amphibious car more similar to car than vehicle.

The small value of the similarity measure between car and ship reflects the fact that these two concepts are significantly different from each other. On the other hand, truck, amphibious car and vehicle are conceptually much closer to car. In certain embodiments, Equation (4) is utilized to compute the similarities of web services to locate the best matched web services in web service database. The following example is employed to illustrate how the web service similarity measure is computed to discover the matching web services:

The desired web service requested by a web service developer that works for a car insurance online quote web service, WS₀. Two existing web services are as follows: (1) a vehicle insurance online quote web service, WS₁, under dynamic cluster online quote 620 illustrated in FIG. 6; and (2) car trade-in online quote web service, WS₂, under dynamic cluster online quote 622 illustrated in FIG. 6. The detailed interface definitions of these web services (the non-I/O part is omitted for simplicity). Web service WS₀ (matched concepts are in parenthesis):
Input parameters: driver ID (person), vehicle ID (car), car model (car model), insurance coverage options (insurance coverage), driver address (person's address)
Output parameters: premium(cost)
Web service WS₁:
Input parameters: owner SSN (person), vehicle number (vehicle), vehicle type (vehicle type), insurance coverage selection (insurance coverage)
Output parameters: rate(cost)
Web service WS₂:
Input parameters: person ID (person), vehicle ID (car), car model (car model), owner address (person's address)
Output parameters: price(price)

Assume that the output parameter matching, and non-I/O parameter matching generate similar measures when comparing WS₀ with WS₁ and WS₂. Simply compute the percentage of same concepts in their input parameters, car trade-in web service WS₂ is more similar to the desired car insurance web service WS₀ than vehicle insurance web service WS₁. This is because 80% of WS₂ input parameters match conceptually with ones of WS₀ while only 40% of WS₁ input parameters do the same. However, the concept dependency analysis and similarity measure provide a different and more accurate result.

In this example, by analyzing the input parameters and searching the web services in web service database, discovery and composition system may identify that some of input parameters of WS₀, car model and driver's address, are the dependent parameters. That is, there are certain existing web services whose inputs is the subset of the WS₀ inputs and whose output contains car model and/or driver's address. For instance, there exists a web service whose input is driver ID and whose output is driver's address. There exists another web service whose input is vehicle ID and whose output is car's model. Further analysis may confirm that driver ID uniquely identifies driver's address and that vehicle ID uniquely identifies car's model. By utilizing these existing services, there is no need to have to match WS₀'s two input parameters: car model and driver's address. Both of them can be removed for the web service similarity measure calculation.

After the parameter dependency analysis and elimination, the similarity measure between the inputs of WS₀ and WS₁ is calculated as follows:

$${WSS}_{i} = \frac{1}{Max ( {I}_{1} , {I}_{2} )} {\sum }_{j = 1}^{Min ( {I}_{1} , {I}_{2} )} {CS}_{j} = \frac{1}{Max ( 3 , 3 )} ( 1 + 0.37 + 1 ) = 0.79$$

By the same token, the similarity measure be in tween the inputs of WS₀ and WS₂ is:

$${WSS}_{i} = \frac{1}{Max ( {I}_{1} , {I}_{2} )} {\sum }_{j = 1}^{Min ( {I}_{1} , {I}_{2} )} {CS}_{j} = \frac{1}{Max ( 3 , 2 )} ( 1 + 1 ) = 0.67$$

The above calculation illustrates how the similarity measure value between car insurance online quote web service WS₀ and vehicle insurance online quote web service WS₁ are larger than the one between WS₀ and WS₂, the car trade-in online quote web service. Both dependency analysis and the measure of concept similarity help remove non-significant parameters and add the missing link between similar parameters.

The scope of the web service parameters perform a role in determining whether there is a web service or a set of web services that are sufficient to realize a desired web service. If the scope of matching web service parameters do not match the ones of desired web service parameters, discovery and composition engine 512 first detects whether there exists such a set of matching web services that their combined scope of parameters will cover the scopes of the desired web service parameters. If such a set does exist, discovery and composition engine further employ an approximation algorithm for set cover problem to identify the minimal set of existing web services that cover the scopes of the parameters of the desired web service.

For instance, assume the desired web service WS₀ wants to cover the US region containing Delaware (DE), District of Columbia (DC), Maryland (MD), Pennsylvania (PA), Virginia (VA), West Virginia (WV) in its address parameter. And assume discovery and composition engine 512 discovers four web services that match the desired web service and their corresponding address parameter covers the states listed below:
WS₁: DE, DC, MD, VA
WS₂: PA, VA, WV
WS₃: DE, MD,
WS₄: MD, VA, DC, WV

The optimal solution in the above example is to utilize WS₁ and WS₂ to compose WS₀. It requires the smallest number of existing web services to cover all the states needed by the desired web service WS₀.

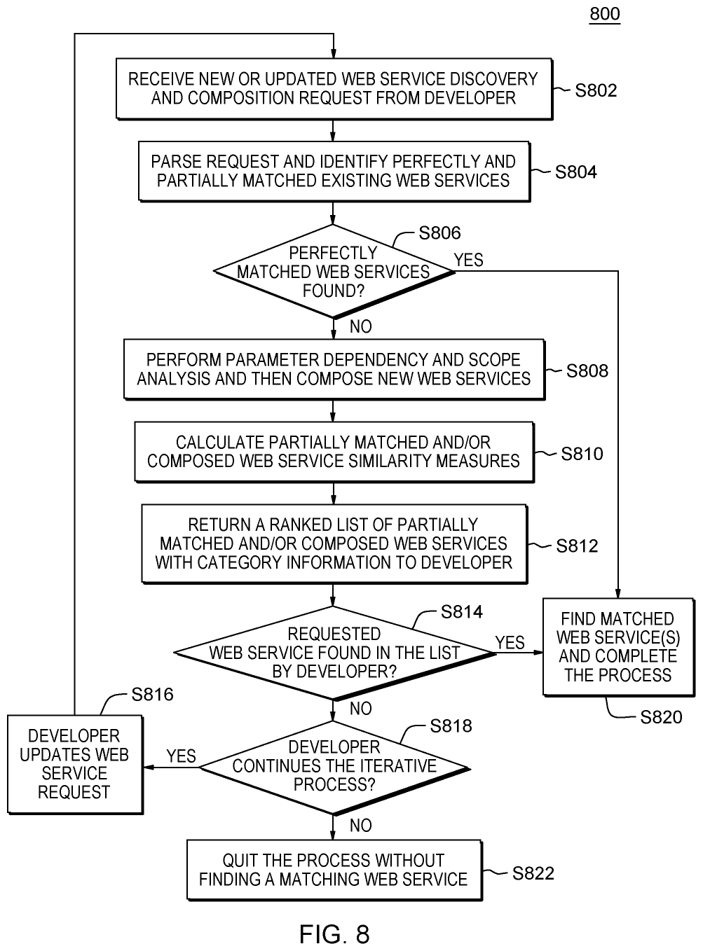

FIG. 8 shows flow diagram 800, where logic is performed by the discovery and composition engine within a web service discovery and composition system. Flow diagram 800 includes the following operations with process flow among and between the operations as shown by arrows in FIG. 8: S802; S804; S806; S808; S810; S812; S814; S816; S818; S820; and S822. Flow diagram 800 demonstrates the logic performed by web service discovery and composition system 502 and web service developer 508 in accordance with certain embodiments.

The process starts at block S802 of FIG. 8. Discovery and composition system 502 receives a new web service discovery and composition request from web service developer 508. Within the request, the developer may, in certain embodiments, provide the information on the input parameters and output parameters of the desired web service, as well as non-I/O parameter descriptions, such as name, URL path, type and other optional parts of the web service.

At block S804, web service API query interpreter 510 parses the web service discovery and composition request with the information from ontology database 504 and dictionary and thesaurus 514. During the parsing process, query interpreter 510 convert I/O parameters and other information into ontology concepts for web service matching in the next step. In certain embodiments, a context-based approach is utilized to increase accuracy of the conversion. In Upon receiving the parsed web service discovery and composition request at block S804, web service discovery and composition engine 512 matches the concepts and their scopes of the desired web service's output, input and other parts with the ones of the web services published in web service database 516.

In The match result may be perfect or partial. If the condition is satisfied at step S806, that is, if perfectly matched one or a plurality of web services have been found, the process proceeds to block S820. At block S820, the process is completed with the result that web service developer 508 finds the web service described in the request.

In certain embodiments, if no perfectly matched web service was identified, the process continues to block S808. At block S808, both the desired web service and the partially matched web services are analyzed by discovery and composition engine 512. The scopes of these web service I/O parameters are examined, and new web services may be created to address the scope mismatch with the existing services, if applicable.

By utilizing concept dependency database 506, discovery and composition engine 512 may efficiently analyze the dependency relationships of the web service I/O parameters to identify and eliminate dependent parameters for web service matching purposes. The result is that the newly created web service(s) may be composed of a plurality of existing web services with additional components to filter and remove duplicate or irrelevant input or output data at step S808. After the identification of partially matched web services and the creation of new better matched web service(s) in the step S804 and S808, the process proceeds to block S810.

At block S810, the similarity measures of the above-mentioned web services are calculated and ranked. In certain embodiments, equations (1) to (5) introduced in the invention are employed to compute web service similarity measures, Then, the process moves to block S812.

At block S812, discovery and composition system 502 returns a ranked list of partially matched existing web services, as well as newly composed web services based on the scope and dependency analysis, to web service developer 508. The ranking is based on the similarity measure between these web services and the desired web service requested by web service developer 508. Along with the list, discovery and composition system 502 also provides the category classification information of these web services.

The process proceeds to step S814, where web service developer 508 reviews the returned web service list and the associated category information to decide whether any of the returned web services satisfies the web service requirements. If the web service is found in the list, the process is completed by proceeding to block S820. If not, the process proceeds to step S818.

At step S818, web service developer 508 further decides whether he wants to continue the iterative process of discovering or composing the desired web service. If yes, the process proceeds to block S816.

At block S816, web service developer 508 updates his web service request based on the information he receives from discovery and composition system 502. The change may include the modifications of the I/O parameters or non-I/O part of the desired web service. Then, the process loops back to block S802 where the updated web service discovery and composition request is processed again by discovery and composition system 502.

If web service developer 508 decides to quit the process at step S818, the process proceeds to block S822 and the process is terminated without finding a matching web service for web service developer 508. This result may be due to the fact that there is no matching web service in web service database 516 and no matching web service can be created with existing web services, or the fact that web service developer 508 does not provide the proper information regarding the web service he seeks.

The aforementioned embodiments provide the effective methods and techniques to search existing relevant web services and compose new web services using existing ones by utilizing the syntactical structure and semantic analysis of web services to measure the similarity of web services and group them in a dynamic hierarchy. This approach is also I/O parameter dependency-aware and scope-aware to create a scalable and efficient web service discovery and composition solution.

In some embodiments, to achieve the goal of developing more scalable methods and systems, a multi-pronged approach is employed in this embodiment. Besides utilizing keyword search to help identify ontology concepts and exploring web service syntactic structure to facilitate web service semantic analysis, this approach focuses more on employing a multidimensional semantic analysis to identify and compose web services.

In some embodiments, the first dimension is a classification hierarchy dimension. The hierarchies of standard categories for web services are based on the classifications created by industry, national or international standard bodies. Categories and subcategories created using standard classifications are usually coarse-grained. The smallest subcategory may contain thousands or more web services. To further categorize these web services into finer groups, a hierarchical clustering algorithm, such as Unweighted Pair Group Method with Arithmetic Mean (UPGMA), can be used to generate these fine-grained groups, called dynamic clusters. These dynamic clusters, under the leaf nodes of a standard classification hierarchy, are created dynamically by utilizing the similarity measures between any two web services.

In some embodiments, the second dimension is semantic concept relationship dimension. The semantic concept relationship refers to the relationships among neighboring ontology concepts. There are multiple types of relationships defined in an ontology between ontology concepts, such as “is-a” relationship, “has-a” relationship or “part-of” relationship. These relationships and neighboring concepts are employed to facilitate the calculation of ontology concept similarity measurements.

In some embodiments, the third dimension is ontology concept distance dimension. This dimension involves several topological distances. The first distance is the shortest length between two ontology concepts in a hierarchical taxonomy graph. The second distance is the depth of their closest common ancestor in the taxonomy hierarchy. The third distance is the arithmetic average of the lengths between these two concepts and their leaf descendants. The second distance and the third distance are utilized to measure the abstraction level of the relevant concepts in the taxonomy hierarchy. All three distances are used to compute the ontology concept similarity measure in the context of web service discovery and composition.

In some embodiments, the fourth dimension is web service parameter dependency dimension. This dimension explores the possibility that some of the web service I/O parameters may not be independent from other I/O parameters given the number of other web services that may be utilized to compose new web services. This parameter dependency analysis may increase the accuracy of the web service similarity measurements and simplify the service discovery and composition process.

In some embodiments, the fifth dimension is a web service parameter scope dimension. In a cloud computing environment, it is not realistic to assume that the I/O parameter scopes of matching web services are always the same. When the scopes of a matching web service's I/O parameters are not the same as the ones of the to-be-matched web service parameters, the greedy based approximation algorithm of the classic set cover problem is utilized to find out whether there exists an optimal set of matching web services that the combined scope of their I/O parameters will cover the scopes of the original ones.

In some embodiments, the formulas and logic utilizing the concepts, algorithms and measures listed in the above dimensions are described herein.

In some embodiments, the methods and techniques to effectively search existing relevant web services and compose new web services use existing methods and techniques. This is done by utilizing the syntactic structure and semantic analysis of web services to measure the similarity of web services and group them in dynamic hierarchies. This approach is also I/O parameter dependency-aware and scope-aware to create a scalable and efficient web service discovery and composition solution.

In some embodiments, more emphasis is placed on this new dimension, as well as how techniques in other dimensions are integrated with ones in this dimension. From both academic and technical points of view, the new distance measure and new formulas/method of calculating web service similarities proposed in third dimension (ontology concept distance dimension) are more important to develop such a solution.

Some embodiments of the present invention may include one, or more, of the following operations, features, characteristics and/or advantages: (i) provides more efficient ranking algorithm to find perfectly matched or partially matched services based on relevance and other criteria; (ii) provides a more scalable system; (iii) allows thousands or more web services in a company repository and/or tens of thousands or more web services in public repositories; (iv) makes it easier to use; (v) no major overhead to make it work for developers; and/or (vi) quick to find and compose services; (vii) use of a multipronged approach; (viii) identifies ontology concepts started with keyword search; (ix) explores web service syntactical structure to facilitate semantic analysis; and/or (x) performs novel multidimensional semantic analysis including: (a) classification hierarchy dimension, (b) semantic concept relationship dimension, (c) concept topological distance dimension, (d) web service parameter dependency dimension, (e) web service parameter scope dimension, and (f) refine discovery and composition through a user guided iterative process. For example, online quote web services (classification hierarchy dimension) may be searched for and found using web service directories according to an embodiment of the present invention.

An embodiment of a method according to the present invention includes the following operations (not necessarily in the following order): (i) dividing a plurality of available web services into a plurality of semantic clusters based on concept similarity measures between web services of the plurality of available web services; (ii) selecting a selected subset of web services to combine based, at least in part, upon the plurality of semantic clusters; and (iii) combining the selected sub-set of web services. In some embodiments, the division of the available web services into clusters is dynamic because it is intermittently repeated with updated information. In some embodiments, the plurality of clusters are fine grained.

Some embodiments of the present invention may include one, or more, of the following operations, features, characteristics and/or advantages: (i) measures concept similarity based hierarchical service discovery and composition; (ii) it is scope aware and dependency aware; (iii) focuses on how to efficiently and automatically discover web services and compose new web services from existing ones; (iv) provides more efficient ranking algorithm to find perfectly matched or partially matched services based on relevance and other criteria; (v) is quite scalable; (vi) can handle thousands or more web services in a company repository and tens of thousands or more web services in public repositories; (vii) easier to use; (viii) no major overhead to make it work for developers; and/or (ix) quick to find and compose services.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer implemented method (CIM) comprising:
receiving a keyword search from a user;
exploring a web service syntactical structure to facilitate semantic analysis;
performing multidimensional semantic analysis based on the exploration of a web service syntactical structure, with the multidimensional semantic analysis including consideration of at least the following dimensions:
classification hierarchy,
semantic concept relationship,
concept topological distance,
web service parameter dependency, and
web service parameter scope; and
identifying a set of web service(s) based, at least in part, upon the multidimensional semantic analysis.

2. The CIM of claim 1 further comprising:
returning the identification of the set of web service(s) to a device of the user.

3. The CIM of claim 1 further comprising:
performing a user guided iterative process to refine the identification of the set of web service(s).

4. The CIM of claim 1 further comprising:
identifying a set of ontology concept(s) based on the keyword search.

5. The CIM of claim 4 further comprising:
determining a set of similarity score values based on the set of ontology concept(s).

6. The CIM of claim 1 wherein the web service syntactical structure includes at least one dynamic cluster.

7. A computer implemented method (CIM) comprising:
receiving a keyword search from a user;
exploring a web service syntactical structure to facilitate semantic analysis;
performing multidimensional semantic analysis based on the exploration of a web service syntactical structure, with the multidimensional semantic analysis including consideration of at least the following dimension: classification hierarchy; and
identifying a set of web service(s) based, at least in part, upon the multidimensional semantic analysis.

8. The CIM of claim 7 further comprising:
returning the identification of the set of web service(s) to a device of the user.

9. The CIM of claim 7 further comprising:
performing a user guided iterative process to refine the identification of the set of web service(s).

10. The CIM of claim 7 further comprising:
identifying a set of ontology concept(s) based on the keyword search.

11. The CIM of claim 10 further comprising:
determining a set of similarity score values based on the set of ontology concept(s).

12. The CIM of claim 7 wherein the web service syntactical structure includes at least one dynamic cluster.

13. A computer implemented method (CIM) comprising:
receiving a keyword search from a user;
exploring a web service syntactical structure to facilitate semantic analysis;
performing multidimensional semantic analysis based on the exploration of a web service syntactical structure, with the multidimensional semantic analysis including consideration of at least the following dimension: web service parameter scope; and
identifying a set of web service(s) based, at least in part, upon the multidimensional semantic analysis.

14. The CIM of claim 13 further comprising:
returning the identification of the set of web service(s) to a device of the user.

15. The CIM of claim 13 further comprising:
performing a user guided iterative process to refine the identification of the set of web service(s).

16. The CIM of claim 13 further comprising:
identifying a set of ontology concept(s) based on the keyword search.

17. The CIM of claim 16 further comprising:
determining a set of similarity score values based on the set of ontology concept(s).

18. The CIM of claim 13 wherein the web service syntactical structure includes at least one dynamic cluster.
